(19) United States
(12) Patent Application Publication
(10) Pub. No.: US 2016/0070082 A1
(43) Pub. Date: Mar. 10, 2016

(54) DUCT ASSEMBLY AND METHOD OF ITS MANUFACTURING

(71) Applicant: TELEFONAKTIEBOLAGET L M ERICSSON (PUBL), Stockholm (SE)

(72) Inventors: Joakim JÖRGENSEN, Hudiksvall (SE); Stefan SÖDERSTRÖM, Hudiksvall (SE); Anders LINDROTH, Hudiksvall (SE); Johan SVANBERG, Hudiksvall (SE)

(21) Appl. No.: 14/786,625

(22) PCT Filed: Apr. 30, 2013
(86) PCT No.: PCT/EP2013/058938

§ 371 Date: Oct. 23, 2015

(51) Int. Cl. G02B 6/44; H02G 3/04; F16L 9/12

(52) U.S. Cl. CPC G02B 6/4459; G02B 6/4494; F16L 9/12; H02G 3/0481; H02G 3/0406

(57) ABSTRACT

A duct assembly is provided. The assembly comprises at least two ducts, a jacket enclosing the at least two ducts, and a filling compound arranged between the jacket and the at least two ducts. The duct assembly comprises first sections, extending along the duct assembly, completely filled with the filling compound between the jacket and the at least two ducts, and second sections, extending along the duct assembly, void of filling compound between the jacket and the at least two ducts. Further a method of manufacturing a duct assembly and a manufacturing arrangement for manufacturing a duct assembly are provided.

### TECHNICAL FIELD

The technical field relates to duct assemblies, methods of manufacturing duct assemblies, and to manufacturing arrangements of manufacturing duct assemblies.

### BACKGROUND

Duct assemblies are used for optical fibres or electric conductors. A duct assembly connects a first and a second apparatus. Via an optical fibre in a duct assembly optical communication between a first and a second apparatus is made possible. Via an electric conductor in a duct assembly an electrical connection between a first and a second apparatus is made possible.

A longitudinally unsealed duct assembly with an open end or a damaged outer jacket will allow transport of water along the inside of the duct assembly. Water at a high location will create a pressure inside the duct assembly at a low location. An apparatus connected to the relevant duct assembly at the low location will thus be subjected to the water in the duct assembly. A connection between the duct assembly and the apparatus, or the apparatus itself has to be devised to withstand water.

A known duct assembly of the type DBfmf provided by the company Emtelle comprises a filler between a jacket and ducts of the duct assembly. However, there are gaps between adjacent ducts in the duct assembly, through which gaps water may be transported if the jacket and the filler should be damaged.

There exists a need for a duct assembly, which will not conduct water if the duct assembly should be damaged.

### SUMMARY

An object is to provide a longitudinally water blocking duct assembly.

According to an aspect, the object is achieved by a duct assembly comprising at least two ducts, a jacket enclosing the at least two ducts, and a filling compound arranged between the jacket and the at least two ducts. Each duct is adapted to receive an optical fibre or an electric conductor. The duct assembly comprises first sections, extending along the duct assembly, completely filled with the filling compound between the jacket and the at least two ducts. The duct assembly further comprises second sections, extending along the duct assembly, void of filling compound between the jacket and the at least two ducts.

Since the filling compound completely fills the first sections as defined above, any water in the duct assembly is prevented from being transported along the duct assembly. As a result, the above mentioned object is achieved.

It has been realized by the inventors that in many cases it may suffice that a duct assembly intermittently blocks water. This comes from the realization that a damaged jacket of the duct assembly will admit water only into the duct assembly in a relevant second section. The two first sections adjacent to the damaged jacket will prevent water from reaching apparatuses connected at the ends of a relevant duct assembly.

A duct assembly comprising first and second sections mentioned above has further advantages such as light weight, lower material costs, higher flexibility, and it is more easily to open for installation purposes—compared to a duct assembly filled with filling compound and without second sections void of filling compound. The higher flexibility provides easy handling during installation, which may be beneficial at least in duct assembly installations in narrow spaces.

A duct, sometimes referred to as a micro duct, comprises a plastic tube adapted to receive and optical fibre or an electric conductor. The duct forms a channel for an optical fibre or an electric conductor. An optical fibre or an electric conductor may be installed in a duct by blowing technique. A duct assembly comprises a number of ducts organized in a certain pattern. The ducts are protected by a jacket. The ducts may have any suitable cross section shape. A round cross section is a typical cross section shape of the ducts. The duct assembly may have any suitable cross section shape. A round, oval, or flat cross section shape is common. A duct assembly connects at least a first and a second apparatus. A duct assembly may be used for connecting first and second apparatuses over long distances, e.g. in the range of kilometres. Via an optical fibre in a duct assembly optical communication between a first and a second apparatus is made possible. Via an electric conductor in a duct assembly an electrical connection between a first and a second apparatus is made possible. Examples of apparatuses which may be connected by optical fibres or electric conductor in a duct assembly may be complex apparatuses such as telecommunication equipment, computers, and data processing equipment, or simple apparatuses such as various connectors for connecting optical fibres or electric conductors to relevant equipment and relays for optical or electrical signals.

Herein, the terms “completely fill” and “completely filled” are to be interpreted as all spaces between the jacket and the ducts, as well as all spaces between the ducts themselves, in a cross section of the duct assembly are filled out. No cavities are present in the cross section, except off course in the channels of the ducts. The cross section is perpendicular to an extension of the duct assembly.

According to embodiments, inter duct spaces may be formed between the at least two ducts, the inter duct spaces in the first sections being completely filled with the filling compound, and wherein the inter duct spaces in the second sections are void of filling compound. In this manner inter duct spaces are also filled with the filling compound to prevent any water from passing the first sections. These embodiments are of particular relevance when the duct assembly comprises ducts formed such that inter duct spaces are formed therebetween, e.g. in the case of more than two ducts having circular cross sections.

A further object is to provide a method of manufacturing a longitudinally water blocking duct assembly.

According to an aspect, the object is achieved by a method of manufacturing a duct assembly, the method comprising:
feeding at least three ducts along a feeding direction through a passage of a die, the at least three ducts being separated from each other at a first position of the die,
injecting a first amount of filling compound into the passage at the first position,
moving the at least three ducts towards each other at a first portion of the die, the first portion being arranged after the first position seen along the feeding direction, and
extruding a jacket around the at least three ducts and the filling compound.

Since the at least three ducts are separated from each other at the first position of the die, were the filling compound is injected into the die, and thereafter the at least three ducts are moved towards each other, it is ensured that inter duct spaces between the at least three ducts are filled with filling compound. As a result, the method produces a duct assembly with filling compound between the ducts, and the above mentioned object is achieved.

According to embodiments, the method may further comprise:
injecting a second amount of filling compound into the passage at a second position of the die, the second position being arranged after the first portion, seen along the feeding direction. In this manner it need not be relied upon that the first amount of filling compound will suffice to fill out also spaces between the jacket and the at least three ducts. The second amount of filling compound will be arranged to fill out any remaining spaces otherwise formed between the jacket and the at least three ducts.

According to embodiments, the method may further comprise:
intermittently stopping the injecting the first amount of filling compound and the injecting the second amount of filling compound while continuing the feeding and the extruding, to thereby form a duct assembly comprising first sections completely filled with the filling compound between the jacket and the at least three ducts as well as between the at least three ducts, and second sections void of filling compound between the jacket and the at least three ducts as well as between the at least three ducts. In this manner it may be ensured that the duct assembly is watertight along the first sections.

It has been realized by the inventors that in many cases it may suffice for a duct assembly to intermittently block water. This comes from the realization that a damaged jacket of the duct assembly will admit water only into the duct assembly in a relevant second section. The two first sections adjacent to the damaged jacket will prevent water from reaching apparatuses connected at the ends of a relevant duct assembly.

In some embodiments it may be possible to use 1/10 or less of the filling compound, compared to a duct assembly filled with filling compound and without second sections void of filling compound.

A further object is to provide a manufacturing arrangement for manufacturing a longitudinally water blocking duct assembly.

According to an aspect, the object is achieved by a manufacturing arrangement for manufacturing a duct assembly. The manufacturing arrangement comprises a die and a jacket extruding arrangement. The die comprises a passage extending through the die for feeding at least three ducts along a feeding direction there through. The die comprises a first injection arrangement for filling compound arranged at a first position along the feeding direction and a first portion of the die. The first injection arrangement is connected to the passage. The first portion is arranged after the first position seen along the feeding direction. The first portion is arranged to move the at least three ducts towards each other.

Since the die is provided with the first injection arrangement for filling compound arranged at the first position before the first portion, which is arranged to move the at least three ducts towards each other, it is ensured that inter duct spaces between the at least three ducts are filled with filling compound in a duct assembly manufactured in the die. As a result, in the manufacturing arrangement a duct assembly with filling compound between the ducts may be manufactured, and the above mentioned object is achieved.

The manufacturing arrangement may form part of an extruder for forming the duct assembly. The die may form part of an extruder head of the extruder. Suitably, the die is arranged before the jacket extruding arrangement. Jacket extruding arrangements as such are known in the art.

According to embodiments, the passage may be wider at an inlet end for the at least three ducts than at an outlet end for the at least three ducts and the filling compound. In this manner it may be ensured that the at least three ducts are moved towards each other as they pass through the passage, during manufacturing of a duct assembly.

According to embodiments, the die may comprise a second injection arrangement for filling compound arranged at a second position of the die along the feeding direction, the second position being arranged after the first portion of the die, seen along the feeding direction, wherein the second injection arrangement is connected to the passage. In this manner it may be ensured that any remaining spaces between the jacket and the at least three ducts are filed with filling compound.

A further object is to provide a longitudinally water blocking duct assembly.

According to an aspect, the object is achieved by a duct assembly comprising at least three ducts, a jacket enclosing the at least three ducts, and a filling compound arranged between the jacket and the at least three ducts. Each duct is adapted to receive an optical fibre or an electric conductor. Filling compound is further arranged between the at least three ducts to completely fill out inter duct spaces therebetween, to form a duct assembly at least partially void of cavities.

Since the filling compound is arranged between the jacket and the at least three ducts as well as in the inter duct spaces between the at least three ducts, any water in the duct assembly is prevented from being transported along the duct assembly. As a result, the above mentioned object is achieved.

According to embodiments, first spaces between the jacket and the at least three ducts are intermittently filed with the filling compound, and the inter duct spaces are intermittently filed with the filling compound such that the duct assembly comprises first sections completely filled with the filling compound between the jacket and the at least three ducts as well as between the at least three ducts, and second sections void of filling compound between the jacket and the at least three ducts as well as between the at least three ducts. In this manner it may be ensured that the duct assembly is watertight along the first sections.

It has been realized by the inventors that in many cases it may suffice for a duct assembly to intermittently block water. This comes from the realization that a damaged jacket of the duct assembly will admit water only into the duct assembly in a relevant second section. The two first sections adjacent to the damaged jacket will prevent water from reaching apparatuses connected at the ends of a relevant duct assembly.

A duct assembly comprising first and second sections mentioned above has further advantages such as light weight, lower material costs, higher flexibility, and it is more easily to open for installation purposes—compared to a duct assembly filled with filling compound and without second sections void of filling compound. The higher flexibility provides easy handling during installation, which may be beneficial at least in duct assembly installations in narrow spaces.

According to embodiments, along the duct assembly the first sections and the second sections may be distributed at a ratio of 1/20-⅕. That is, between 1/20 and ⅕ of a length along the duct assembly may comprise first sections. The remainder may comprise second sections. In this manner a distribution of first and second sections suitable for blocking water along the duct assembly may be achieved.

Further features of and advantages with embodiments herein will become apparent when studying the appended claims and the following detailed description. Those skilled in the art will realize that different features of embodiments may be combined to create embodiments other than those described in the following, without departing from the scope as defined by the appended claims.

### BRIEF DESCRIPTION OF THE DRAWINGS

The various aspects, including particular features and advantages, will be readily understood from the following detailed description and the accompanying drawings, in which:

FIGS. 1a and 1b illustrate a duct assembly according to embodiments and partial cross sections through the duct assembly,

FIGS. 2a and 2b illustrate enlarged cross sections of duct assemblies according to embodiments,

FIG. 3 illustrates schematically embodiments of a method of manufacturing a duct assembly,

FIGS. 4 and 5 illustrates embodiments of a manufacturing arrangement for manufacturing a duct assembly, and

FIG. 6 illustrates a partial cross section through a duct assembly 2 according to embodiments.

### DETAILED DESCRIPTION

Example embodiments will now be described more fully with reference to the accompanying drawings. Disclosed features of example embodiments may be combined as readily understood by one of ordinary skill in the art. Like numbers refer to like elements throughout. Well-known functions or constructions will not necessarily be described in detail for brevity and/or clarity.

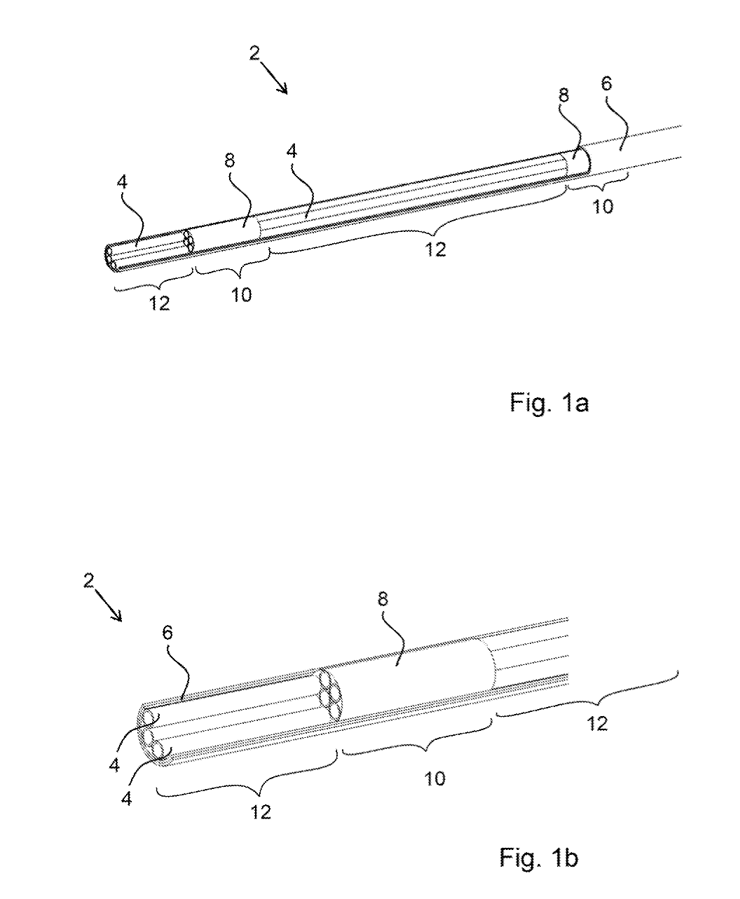

FIGS. 1a and 1b illustrate a duct assembly 2 according to embodiments and partial cross sections through the duct assembly 2. The duct assembly 2 comprises at least two ducts 4. These embodiments are illustrated with 7 ducts 4. However, the duct assembly 2 may comprise any number of ducts 4. Provided purely as an example, the number of ducts 4 may range between 2 and 26, higher numbers of ducts 4 are also conceived of. A jacket 6 encloses the ducts 4. A filling compound 8 is arranged between the jacket 6 and the ducts 4. Provided purely as an example, it may be mentioned that a diameter of a duct assembly 2 comprising 26 ducts 4 may be approximately 38 mm.

More specifically, the duct assembly 2 comprises first sections 10, extending along the duct assembly 2, the first sections 10 being completely filled with the filling compound 8 between the jacket 6 and the ducts 4. Further, the duct assembly 2 comprises second sections 12, extending along the duct assembly 2, the second sections 12 being void of filling compound between the jacket 6 and the ducts 4. In these illustrated embodiments, comprising 7 ducts 4, between the ducts 4 inter duct spaces are formed. The inter duct spaces in the first sections 10 are completely filled with the filling compound 8. The inter duct spaces in the second sections 12 are void of filling compound. Thus, the duct assembly 2 is intermittently completely filled with filling compound 8.

As may be clearly seen in FIG. 1b, in the first sections 10, the filling compound 8 completely fills all spaces between the ducts 4 as well as all spaces between the jacket 6 and the ducts 4. In the first sections 10 in a cross section perpendicular to an extension of the duct assembly 2 thus, no cavities are present. The filling compound 8 in the first sections 10 water-tightly seals the second sections 12 from each other. Thus, any water inside the jacket 6 in the second sections 12 is prevented from passing the first sections 10.

Along the duct assembly 2, the first sections 10 and the second sections 12 may be distributed at a ratio of 1/20-⅕. That is, between 1/20 and ⅕ of a length along the duct assembly 2 may comprise first sections 10 and the remainder may comprise second sections 12. According to some embodiments, along the duct assembly 2 the first sections 10 and the second sections 12 may be distributed at a ratio of about 1/10. That is, about 1/10 of a length along the duct assembly 2 may comprise first sections 10 and the remainder may comprise second sections 12.

Provided purely as an example, the first sections 10 may have lengths of 5-25 cm. According to some embodiments, the first sections 10 may have lengths of about 15 cm.

According to embodiments, the at least two ducts 4 may comprise a polyolefin material.

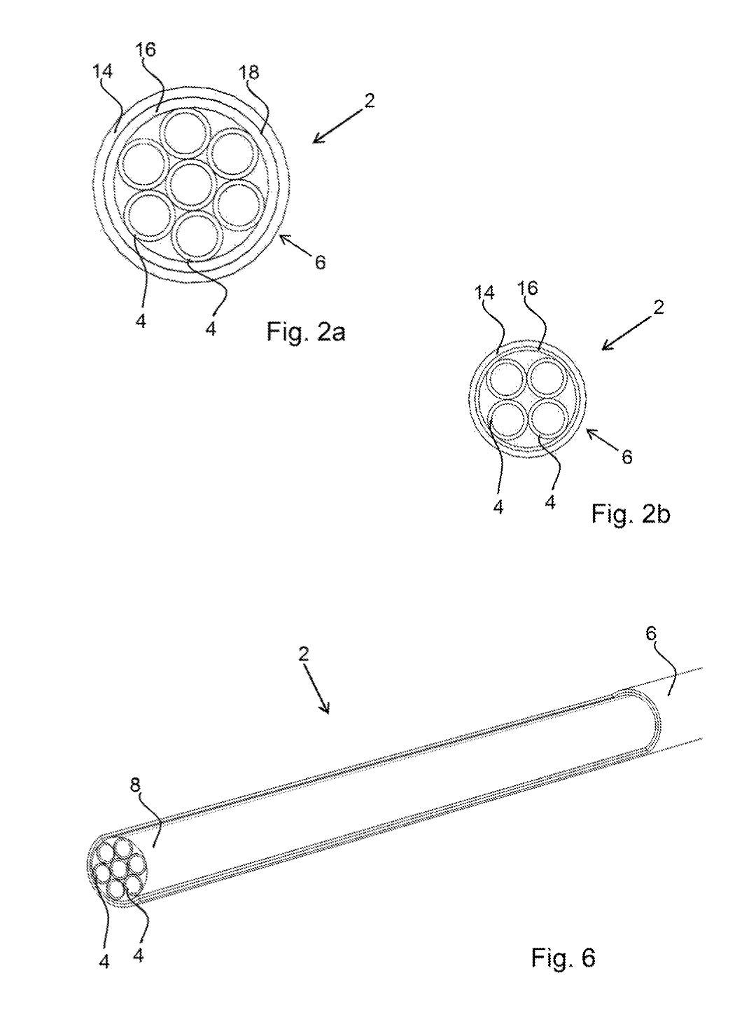

FIGS. 2a and 2b illustrate enlarged cross sections of duct assemblies 2 according to embodiments. The FIG. 2a embodiments correspond to the embodiments of FIGS. 1a and 1b, i.e. a duct assembly 2 comprising 7 ducts 4. The FIG. 2b embodiments comprise 4 ducts 4.

The jacket 6 may comprise a first layer 14 and second layer 16. For instance, the jacket 6 may comprise a Polypropylene layer, and a Polyethylene layer. Alternatively, the jacket 6 may comprise only one layer or more than two layers.

According to embodiments, the jacket 6 may comprise an aluminium layer 18. The aluminium layer 18 e.g. may comprise an aluminium foil. The aluminium layer 18 may be arranged between the first and second layers 14, 16, as illustrated in FIG. 2b. Alternatively, the aluminium layer 18 may be arranged on an inside of the second layer 16.

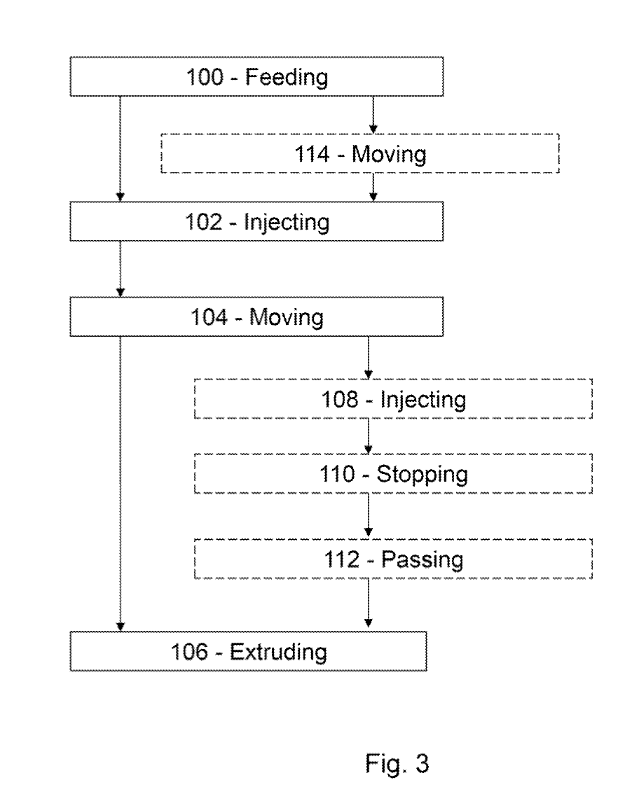

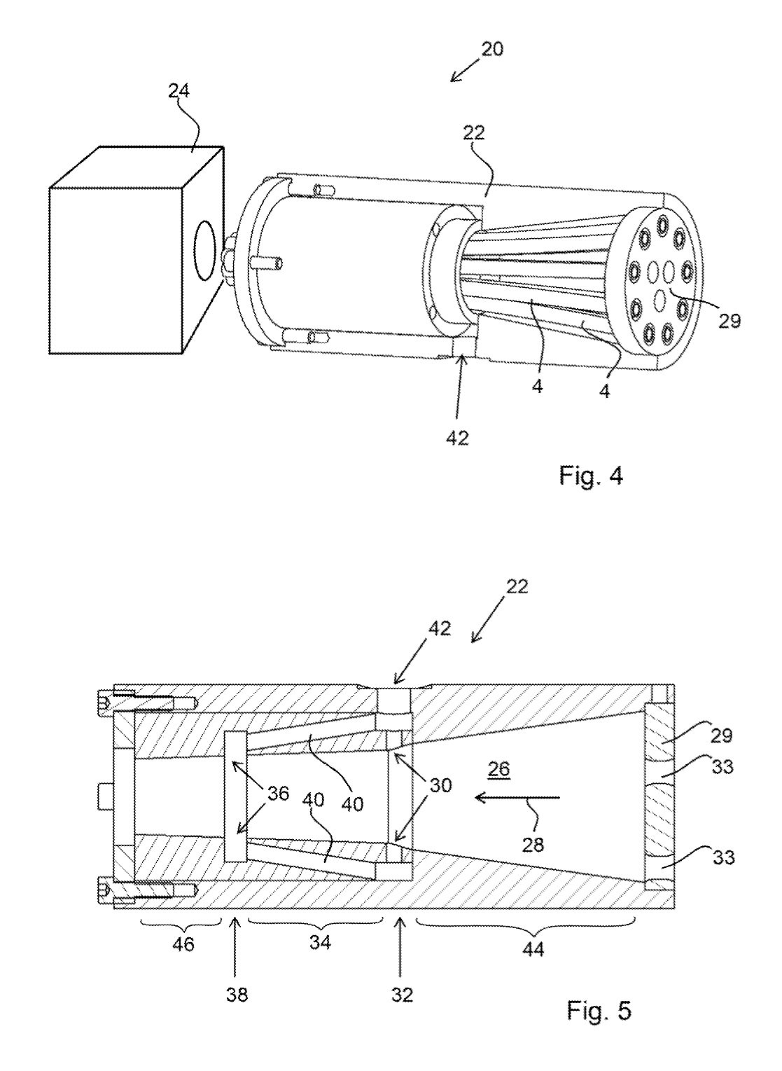

FIG. 3 illustrates schematically embodiments of a method of manufacturing a duct assembly. The method may for instance be performed in a manufacturing arrangement as described below in connection with FIGS. 4 and 5.

The method comprises:
feeding (100) at least three ducts along a feeding direction through a passage of a die, the at least three ducts being separated from each other at a first position of the die,
injecting (102) a first amount of filling compound into the passage at the first position,
moving (104) the at least three ducts towards each other at a first portion of the die, the first portion being arranged after the first position seen along the feeding direction, and
extruding (106) a jacket around the at least three ducts and the filling compound.

As mentioned initially, the method ensures that inter duct spaces between the at least three ducts are filled with filling compound. As a result, the method produces a duct assembly with filling compound between the ducts, i.e. a duct assembly that prevents water from being transported along the duct assembly. It is to be noted that duct assemblies 2 intermittently completely filled with filling compound, as described in connection with FIGS. 1a and 1b, as well as duct assemblies 2 completely filled with filling compound along their entire length, as described below in connection with FIG. 6, may be manufactured using the method according to these embodiments. The filling compound may be a compound which is heated prior to the injecting into the passage. For instance, the filling compound may be the compound Euromelt 322, ECA No: MVK01214 from the manufacturer Henkel Adhesive Technologies AB.

According to embodiments, the method may further comprise:
injecting (108) a second amount of filling compound into the passage at a second position of the die, the second position being arranged after the first portion, seen along the feeding direction.

According to embodiments, the method may further comprise:
intermittently stopping (110) the injecting (102) the first amount of filling compound and the injecting (108) the second amount of filling compound while continuing the feeding (100) and the extruding (106), to thereby form a duct assembly comprising first sections completely filled with the filling compound between the jacket and the at least three ducts as well as between the at least three ducts, and second sections void of filling compound between the jacket and the at least three ducts as well as between the at least three ducts. In this manner a duct assembly 2 intermittently completely filled with filling compound, as described in connection with FIGS. 1a and 1b, may be manufactured.

According to embodiments, the method may further comprise:
passing (112) the at least three ducts and the filling compound through a second portion of the die, the second portion being arranged after the second position, seen along the feeding direction. In this manner the filling compound may be distributed evenly in the second portion along the ducts of the duct assembly prior to extruding (106) the jacket around the at least three ducts and the filling compound.

According to embodiments, the method may further comprise:
moving (114) the at least three ducts towards each other at a converging portion of the die, the converging portion being arranged before the first position, seen along the feeding direction. In this manner the ducts may be feed to the die from spread apart positions and be subjected to an initial converging in the converging portion of the die prior to the moving (104) the at least three ducts towards each other at the first portion of the die.

According to embodiments, the first portion of the die may be converging along the feeding direction. In this manner the ducts may be gradually moved towards each other as they pass along the first portion.

FIG. 4 illustrates embodiments of a manufacturing arrangement 20 for manufacturing a duct assembly, e.g. a duct assembly 2 as discussed above in relation to FIGS. 1a and 1b or a duct assembly as discussed below in connection with FIG. 6. The manufacturing arrangement 20 comprises a die 22 and a jacket extruding arrangement 24. In FIG. 4 the die 22 is illustrated in a partial cross section. The jacket extruding arrangement 24 is well known in the art and thus, only schematically illustrated in FIG. 4. FIG. 5 illustrates a cross section through the die 22.

The die 22 comprises a passage 26 extending through the die 22 for feeding at least three ducts 4 along a feeding direction 28 through the passage 26. In the illustrated embodiments the passage 26 is adapted for feeding 12 ducts 4 there through. A guiding plate 29 for the ducts 4 is provided at an inlet end of the die 22. The guiding plate 29 comprises 12 through holes 33, one each for each duct 4. Thus, the ducts 4 are orderly lead into the passage 26 of the die 22. The passage 26 of the die 22 is wider at the inlet end for the at least three ducts than at an outlet end for the at least three ducts and the filling compound.

The die 22 comprises a first injection arrangement 30 for filling compound arranged at a first position 32 along the feeding direction 28, and a first portion 34 of the die 22. The first injection arrangement 30 is connected to the passage 26. The first portion 34 is arranged after the first position 32, seen along the feeding direction 28. The first portion 34 is arranged to move the at least three ducts 4 towards each other during manufacturing of a duct assembly in the manufacturing arrangement 20. The first portion 34 of the die 22 is converging along the feeding direction 28. Thus, the ducts 4 are moved towards each other as they pass through the first portion 34.

Through the first injection arrangement 30, filling compound is arranged to be injected into the passage 26 of the die 22. At the first position 32 the at least three ducts 4 are separate from each other. Thus, the filling compound is injected between the ducts 4 before the first portion 34. In the first portion 34 the at least three ducts 4 are moved towards each other. Thus, inter duct spaces between the at least three ducts 4 are filled with filling compound in a duct assembly manufactured in the die 22. In the jacket extruding arrangement 24 a jacket may be formed around the at least three ducts 4 to form a duct assembly with filling compound between the ducts 4.

The die 22 comprises a second injection arrangement 36 for filling compound arranged at a second position 38 of the die 22 along the feeding direction. The second injection arrangement (36) is connected to the passage (26). The second position is 38 arranged after the first portion 34 of the die 22, seen along the feeding direction 28. In these embodiments the second injection arrangement 36 is interconnected with the first injection arrangement via channels 40. In this manner the die 22 need only comprise one filling compound inlet 42, from which filling compound is conducted to the first and second injection arrangements 30, 36.

The die 22 comprises a converging portion 44, the converging portion 44 being arranged before the first position 32, seen along the feeding direction 28, wherein the converging portion 22 is arranged for moving the at least three ducts 4 towards each other. Along the converging portion 44 thus, the ducts 4 may be displaced from initial positions in the guiding plate 29 at the inlet end of the die 22 to positions at a distance from each other suitable for injecting the filling compound between the ducts 4 at the first position 32.

The die 22 comprises a second portion 46, the second portion 46 being arranged after the second position 38, seen along the feeding direction 28. The filling compound may thus be distributed evenly along the outer ducts 4 in the second portion 46 during manufacturing of a duct assembly. The ducts and the filling compound thus may form a smooth foundation for the jacket of the duct assembly to be extruded thereon in the jacket extruding arrangement 24.

As mentioned, the passage 26 extends through the die 22. The passage 22 extends through the first portion 34. The passage 22 extends through the converging portion 44. The passage 22 extends through the second portion 46. In essence, the ducts 4 are widely spread when entering the passage 26. At the first position 32 the filling compound will penetrate the inter duct spaces. In the first portion 34, the ducts 4 will be forced towards each other, and the filling compound will spread to the outer side of the ducts 4.

FIG. 6 illustrates a partial cross section through a duct assembly 2 according to embodiments. The duct assembly 2 comprises at least three ducts 4, a jacket 6 enclosing the at least three ducts 4, and a filling compound 8 arranged between the jacket 6 and the at least three ducts 4.

Each duct 4 is adapted to receive an optical fibre or an electric conductor. Filling compound 8 is further arranged between the at least three ducts 4 to completely fill out inter duct spaces therebetween. The duct assembly 2 is thus, void of cavities.

As opposed to the embodiments of FIGS. 1a and 1b, the duct assembly 2 of the embodiments illustrated in FIG. 6 do not comprise sections corresponding to the second sections 12 void of filling compound. The duct assembly 2 illustrated in FIG. 6 is completely filled with filling compound along its entire length.

However, a modification of the FIG. 6 embodiments would render these embodiments similar to the FIGS. 1a and 1b embodiments. With reference to FIGS. 1a and 1b, in such modified embodiments, first spaces between the jacket 6 and the at least three ducts 4 are intermittently filed with the filling compound 8, and the inter duct spaces are intermittently filed with the filling compound such that the duct assembly 2 comprises first sections 10 completely filled with the filling compound 8 between the jacket 6 and the at least three ducts 4 as well as between the at least three ducts 4, and second sections 12 void of filling compound between the jacket 6 and the at least three ducts 4 as well as between the at least three ducts 4. Such a duct assembly 2 is partially void of cavities.

According to embodiments, the duct assembly 2 may be manufactured according to the method discussed in connection with FIG. 3.

According to embodiments, along the duct assembly 2 the first sections 10 and the second sections 12 may be distributed at a ratio of 1/20-⅕ . That is, between 1/20 and ⅕ of a length along the duct assembly 2 may comprise first sections 10. The remainder of the length along the duct assembly 2 may comprise second sections 12.

According to embodiments, the filling compound in the first sections 10 water-tightly seals the second sections 12 from each other.

According to embodiments, the first sections 10 and the second sections 12 may be distributed at a ratio of about 1/10.

According to embodiments, the at least three ducts 4 may comprise a polyolefin material.

According to embodiments, the jacket 6 may comprises a Polypropylene layer, and Polyethylene layer.

According to embodiments, the jacket 6 may comprises an aluminium layer.

Example embodiments described above may be combined as understood by a person skilled in the art. Although reference has been made to example embodiments, many different alterations, modifications and the like will become apparent for those skilled in the art. Therefore, it is to be understood that the foregoing is illustrative of various example embodiments and that the invention is defined only the appended claims.

As used herein, the term “comprising” or “comprises” is open-ended, and includes one or more stated features, elements, steps, components or functions but does not preclude the presence or addition of one or more other features, elements, steps, components, functions or groups thereof.

It will be understood that although the terms first, second, etc. may be used herein to describe various portions, layers and/or sections, these portions, layers and/or sections should not be limited by these terms. These terms are only used top distinguish one portion, layer or section from another portion, layer or section. Thus, a portion, layer or section discussed herein could be termed a second portion, layer or section without departing from the teachings herein.

1. A duct assembly comprising at least two ducts, a jacket enclosing the at least two ducts, and a filling compound arranged between the jacket and the at least two ducts, wherein each duct is adapted to receive an optical fibre or an electric conductor,
wherein the duct assembly comprises first sections, extending along the duct assembly, completely filled with the filling compound between the jacket and the at least two ducts, and second sections, extending along the duct assembly, void of filling compound between the jacket and the at least two ducts .

2. The duct assembly according to claim 1, wherein inter duct spaces are formed between the at least two ducts, the inter duct spaces in the first sections being completely filled with the filling compound, and wherein the inter duct spaces in the second sections are void of filling compound.

3. The duct assembly according to claim 1, wherein the filling compound in the first sections water-tightly seals the second sections from each other.

4. The duct assembly according to claim 1, wherein along the duct assembly the first sections and the second sections are distributed at a ratio of 1/20-⅕.

5. The duct assembly according to claim 4, wherein along the duct assembly the first sections and the second sections are distributed at a ratio of about 1/10.

6. The duct assembly according to claim 1, wherein the at least two ducts comprise a polyolefin material.

7. The duct assembly according to claim 1, wherein the jacket comprises a Polypropylene layer, and a Polyethylene layer.

8. The duct assembly according to claim 1, wherein the jacket comprises an aluminium layer.

9. A method of manufacturing a duct assembly, the method comprising:
feeding at least three ducts along a feeding direction through a passage of a die, the at least three ducts being separated from each other at a first position of the die,
injecting a first amount of filling compound into the passage at the first position,
moving the at least three ducts towards each other at a first portion of the die, the first portion being arranged after the first position seen along the feeding direction, and
extruding a jacket around the at least three ducts and the filling compound.

10. The method according to claim 9, comprising:
injecting a second amount of filling compound into the passage at a second position of the die, the second position being arranged after the first portion, seen along the feeding direction.

11. The method according to claim 10, comprising:
intermittently stopping the injecting the first amount of filling compound and the injecting the second amount of filling compound while continuing the feeding and the extruding, to thereby form a duct assembly comprising first sections completely filled with the filling compound between the jacket and the at least three ducts as well as between the at least three ducts, and second sections void of filling compound between the jacket and the at least three ducts as well as between the at least three ducts.

12. The method according to claim 10, comprising:
passing the at least three ducts and the filling compound through a second portion of the die, the second portion being arranged after the second position, seen along the feeding direction.

13. The method according to claim 9, comprising:
moving the at least three ducts towards each other at a converging portion of the die, the converging portion being arranged before the first position, seen along the feeding direction.

14. The method according to claim 9, wherein the first portion of the die is converging along the feeding direction.

15. A manufacturing arrangement for manufacturing a duct assembly, the manufacturing arrangement comprising a die and a jacket extruding arrangement, wherein the die comprises a passage extending through the die for feeding at least three ducts along a feeding direction there through,
wherein the comprises a first injection arrangement for filling compound arranged at a first position along the feeding direction and a first die portion of the die, wherein the first injection arrangement is connected to the passage, and wherein the first portion is arranged after the first position seen along the feeding direction, wherein the first portion is arranged to move the at least three ducts towards each other.

16. The manufacturing arrangement according to claim 15, wherein the passage is wider at an inlet end for the at least three ducts than at an outlet end for the at least three ducts and the filling compound.

17. The manufacturing arrangement according to claim 15, wherein the die comprises a second injection arrangement for filling compound arranged at a second position of the die along the feeding direction, the second position being arranged after the first portion of the die, seen along the feeding direction, and wherein the second injection arrangement is connected to the passage.

18. The manufacturing arrangement according to claims 15, wherein the die comprises a converging portion, the converging portion being arranged before the first position, seen along the feeding direction, wherein the converging portion is arranged for moving the at least three ducts towards each other.

19. The manufacturing arrangement according to claim 18, wherein the die comprises a second portion, the second portion being arranged after the second position, seen along the feeding direction.

20. The manufacturing arrangement according to claim 15, wherein the first portion of the die is converging along the feeding direction.

21. A duct assembly comprising at least three ducts, a jacket enclosing the at least three ducts, and a filling compound arranged between the jacket and the at least three ducts, wherein each duct is adapted to receive an optical fibre or an electric conductor
wherein the filling compound is further arranged between the at least three ducts to completely fill out inter duct spaces therebetween, to form a duct assembly at least partially void of cavities.

22. The duct assembly according to claim 21, wherein the duct assembly is manufactured according to the method according to claim 9.

23. The duct assembly according to claim 21, wherein first spaces between the jacket and the at least three ducts are intermittently filed with the filling compound, and the inter duct spaces are intermittently filed with the filling compound such that the duct assembly comprises first sections completely filled with the filling compound between the jacket and the at least three ducts as well as between the at least three ducts, and second sections void of filling compound between the jacket and the at least three ducts as well as between the at least three ducts.

24. The duct assembly according to claim 23, wherein the filling compound in the first sections water-tightly seal the second sections from each other.

25. The duct assembly according to claim 23, wherein along the duct assembly the first sections and the second sections are distributed at a ratio of 1/20-⅕.

26. The duct assembly according to claim 25, wherein along the duct assembly the first sections and the second sections are distributed at a ratio of about 1/10.

27. The duct assembly according to claim 21, wherein the at least three ducts comprise a polyolefin material.

28. The duct assembly according to claim 21, wherein the jacket comprises a Polypropylene layer, and Polyethylene layer.

29. The duct assembly according to claim 21, wherein the jacket comprises an aluminium layer.
